(19) United States
(12) Patent Application Publication
(10) Pub. No.: US 2026/0267606 A1
(43) Pub. Date: Sep. 10, 2026

(54) COMPUTER IMPLEMENTED SYSTEMS AND METHODS OF ADDITION OF NUMBERS REPRESENTED IN A LOGARITHMIC NUMBER SYSTEM

(71) Applicant: LEMURIAN LABS INC., Oakville (CA)

(72) Inventors: Vassil DIMITROV, Calgary (CA); Sanjay DAWANI, Oakville (CA)

(73) Assignee: LEMURIAN LABS INC., Oakville, ON (CA)

(21) Appl. No.: 19/167,636

(22) PCT Filed: Mar. 22, 2024
(86) PCT No.: PCT/IB2024/052784

§ 371 Date: Sep. 22, 2025

Related U.S. Application Data
(60) Provisional application No. 63/491,601, filed on Mar. 22, 2023.

(51) Int. Cl. G06F 7/483; G06F 7/485; G06F 17/17

(52) U.S. Cl. CPC G06F 7/4833; G06F 7/485; G06F 17/17

(57) ABSTRACT

A computer-implemented method of addition of real numbers represented in a multidimensional logarithmic number system (MDLNS) includes representing two real numbers X and Y in an MDLNS, wherein the MDLNS representations of X and Y includes at least two bases B1 and B2, as follows: X=s1*(B1\hat{ }a)*(B2\hat{ }b), and Y=s2*(B1\hat{ }c)*(B2\hat{ }d). Wherein s1 and s2 are each a sign of value plus or minus one, and wherein a, b, c and d are exponents. A condition is imposed on the signs of the exponents wherein: a is positive, b is negative, c is negative and d is positive. The representation of the sum of X+Y in the log domain is expanded as follows: log (X+Y)=log (s1*(B1\hat{ }a)*(B2\hat{ }b)+s2*(B1\hat{ }c)*(B2\hat{ }d))=log (s1*(B1\hat{ }a*B2\hat{ }d)*(B2\hat{ }(b−d)+(s2/s1)*B1\hat{ }(c−a))), wherein (b−d) is a negative exponent and (c−a) is a negative exponent.

### CROSS REFERENCE TO RELATED APPLICATIONS

This application is a non-provisional application of, and claims the benefit of the filing date of, U.S. provisional application 63/491,601, filed Mar. 22, 2023, entitled: “COMPUTER IMPLEMENTED SYSTEMS AND METHODS OF ADDITION OF NUMBERS REPRESENTED IN A LOGARITHMIC NUMBER SYSTEM,” the contents of which are incorporated herein by reference in their entirety.

### TECHNICAL FIELD

The present disclosure relates to improvements to processes including, but not limited to, digital signal processing applications, image compression, seismic data processing, based on utilizing computer implemented systems and methods of representation and manipulation of data represented in a logarithmic number system.

### BACKGROUND

The popularity of logarithmic number systems (LNS) for data representation and manipulation continues to grow. As a computer implemented data representation scheme, logarithmic number systems have been successfully used to encode and manipulate numerical data in various applications, such as, for example, digital signal processing applications, image compression, seismic data processing, to name a few.

The main purpose of the logarithmic encoding is to convert binary data (such as fixed point or floating-point binary data) to the logarithmic domain, where multiplication processes are transformed into simpler, faster and less memory intensive addition processes. Other fundamental data operations, such as division and square roots, are also substantially simplified over a conventional binary data representation system. For example, division operations are transformed into subtraction operations and square root processes are transformed into a bit-shift operation. Table 1 below outlines those advantageous features.

TABLE 1

| | | Implementation of the |
|---|---|---|
| Operation floating or | Transformation into | operation in logarithmic |
| fixed-point domain | logarithmic domain | domain |
| x*y | log(x*y) | log(x) + log(y) |
| x/y | log(x/y) | log(x) − log(y) |
| sqrt(x) | log(sqrt(x)) | ½ log(x) |

Problematically however, within prior art logarithmic data representation systems, the fundamental arithmetic operations of addition and subtraction become more difficult, time consuming and require more memory capacity than conventional binary data systems and hence, present processing challenges in computing environments.

### BRIEF DESCRIPTION

The present disclosure offers advantages and alternatives over the prior art by providing novel systems and methods of addition of two real numbers X and Y represented in a multidimensional logarithmic number system (MDLNS). The MDLNS representations of X and Y can be as follows: X=s1*(B1\hat{ }a)*(B2\hat{ }b), and Y=s2*(B1\hat{ }c)*(B2\hat{ }d), wherein B1 and B2 are bases, s1 and s2 are plus or minus one (i.e., signs), and a, b, c and d are exponents. Advantageously, the exponents have the following predetermined conditions imposed on them:
I. that a, b, c and d are integers, and
II. that a is positive, b is negative, c is negative and d is positive.

By imposing the above conditions, the addition of X and Y in the log domain can be expanded in the following novel fashion: X+Y=s1\hat{ }(B1\hat{ }a*B2\hat{ }d)*(B2\hat{ }(b−d)+(s2/s1)*B1\hat{ }(c−a)), wherein the exponents (b−d) and (c−a) are negative. Importantly, this makes the sum term B2\hat{ }(b−d)+(s2/s1)*B1\hat{ }(c−a) small, e.g. less than 1 and preferably less than 0.5. Accordingly, the sum term can be accurately approximated in the form of the product term s3*(B1\hat{ }x)*(B2*y) within at least 4 bits of precision or within at least 6.4 percent, wherein s3 is the sign and x and y are integer exponents. The approximated product term can be substituted for the sum term to obtain an accurate approximation of X+Y in the form of (s1*s3)*(B1\hat{ }(a+x))*(B2\hat{ }(d+y)) within at least 4 bits of precision or within at least 6.4 percent.

A computer-implemented method of addition of real numbers represented in a multidimensional logarithmic number system (MDLNS), in accordance with one or more aspects of the present disclosure includes representing two real numbers X and Y in an MDLNS, wherein the MDLNS representations of X and Y includes at least two bases B1 and B2, as follows: X=s1*(B1\hat{ }a)*(B2\hat{ }b), and Y=s2*(B1\hat{ }c)*(B2\hat{ }d). Wherein s1 and s2 are each a sign of value plus or minus one, and wherein a, b, c and d are exponents. Conditions are imposed on the exponents as follows: a, b, c and d are integers, and a is positive, b is negative, c is negative and d is positive. The representation of the sum of X+Y in the log domain is expanded as follows: log (X+Y)=log (s1*(B1\hat{ }a)*(B2\hat{ }B)+s2*(B1\hat{ }c)*(B2\hat{ }d))=log (s1*(B1\hat{ }a*B2\hat{ }d)*(B2\hat{ }(b−d)+(s2/s1)*B1\hat{ }(c−a))), wherein (b−d) is a negative exponent and (c−a) is a negative exponent.

In some examples of the method, the value of the sum term B2\hat{ }(b−d)+(s2/s1)*B1\hat{ }(c−a) is approximated in the form of a product term as follows: B2\hat{ }(b−d)+(s2/s1)*B1\hat{ }(c−a)=s3*(B1\hat{ }x)*(B2*y) within at least 4 bits of precision or within at least 6.4 percent, wherein s3 is a sign of value plus or minus one and wherein x and y are exponents. The representation of the sum of X+Y in the log domain is simplified as follows:

| | |
|---|---|
| i. | log (X+Y) = log (s1*(B1\hat{ }a*B2\hat{ }d)*(B2\hat{ }(b−d) + |
| | (s2/s1)*B1\hat{ }(c−a))) = |
| ii. | log (s1*(B1\hat{ }a*B2\hat{ }d)* s3*(B1\hat{ }x)*(B2*y)) within at least 4 |
| | bits of precision or within at least 6.4 percent = |
| iii. | log ((s1*s3)*(B1\hat{ }(a+x))*(B2\hat{ }(d+y))), |
| iv. | wherein X+Y = (s1*s3)*(B1\hat{ }(a+x))*(B2\hat{ }(d+y)) |
| | within at least 4 bits of precision or within at |
| | least 6.4 percent. |

In some examples of the method, if initially the sign of the exponent a is negative, rather than positive, and the sign of the exponent b is positive, rather than negative, then the method further includes obtaining an approximate value of 1 represented in the MDLNS as follows: 1=(B1\hat{ }e)*(B2\hat{ }f) within at least 4 bits of precision or within at least 6.4 percent. Wherein e is a positive exponent having an absolute value greater than a, and wherein f is a negative exponent having an absolute value greater than b. The term (B1\hat{ }a)*(B2\hat{ }b) is multiplied and manipulated by the approximate value of 1 as follows: (B1\hat{ }a)*(B2\hat{ }b)*(B1\hat{ }e)*(B2\hat{ }f)=B1\hat{ }(a+e)*B2\hat{ }(b+f))=(B1\hat{ }a)*(B2^{A}b) within at least 4 bits of precision or within at least 6.4 percent, wherein (a+e) is positive and (b+f) is negative. B1\hat{ }(a+e)*B2\hat{ }(b+f)) is then substituted for (B1\hat{ }a)*(B2\hat{ }b) in the method.

In some examples of the method, if initially the sign of the exponent c is positive, rather than negative, and the sign of the exponent d is negative, rather than positive, then the method further includes obtaining an approximate value of 1 represented in the MDLNS as follows: 1=(B1\hat{ }e)*(B2\hat{ }f) within at least 4 bits of precision or within at least 6.4 percent. Wherein e is a negative exponent having an absolute value greater than c, and wherein f is a positive exponent having an absolute value greater than d. The term (B1\hat{ }c)*(B2\hat{ }d̅) is multiplied and manipulated by the approximate value of 1 as follows: (B1\hat{ }c)*(B2\hat{ }d)*(B1\hat{ }e)*(B2\hat{ }f)=B1\hat{ }(c+e)*B2\hat{ }(d+f))=(B1\hat{ }c)*(B2\hat{ }d) within at least 4 bits of precision or within at least 6.4 percent, wherein (c+e) is negative and (d+f) is positive. B1\hat{ }(c+e)*B2\hat{ }(d+f)) is then substituted for (B1 \hat{ }c)*(B2\hat{ }d) in the method.

A computer system in accordance with one or more aspects of the present disclosure includes a memory, and a processor in communication with the memory. An algorithm is stored in the memory as a set of instructions for execution by the processor. The algorithm is programmed to perform a method of addition of real numbers represented in a multidimensional logarithmic number system (MDLNS). The method includes representing two real numbers X and Y in an MDLNS, wherein the MDLNS representations of X and Y includes at least two bases B1 and B2, as follows: X=s1*(B1\hat{ }a)*(B2\hat{ }b) and Y=s2*(B1\hat{ }c)*(B2\hat{ }d). Wherein s1 and s2 are each a sign of value plus or minus one, and wherein a, b, c and d are exponents. Conditions are imposed on the exponents as follows: a, b, c and d are integers, and a is positive, b is negative, c is negative and d is positive. The representation of the sum of X+Y in the log domain is expanded as follows: log (X+Y)=log (s1*(B1\hat{ }a)*(B2\hat{ }b)+s2*(B1\hat{ }c)*(B2\hat{ }d))=log (s1*(B1\hat{ }a*B2\hat{ }d)*(B2\hat{ }(b−d)+(s2/s1)*B1\hat{ }(c−a))), wherein (b−d) is a negative exponent and (c−a) is a negative exponent.

A computer program product in accordance with one or more aspects of the present invention includes at least one non-transitory computer readable storage medium storing instructions for execution by a processor to perform a method. The method includes representing two real numbers X and Y in a multidimensional logarithmic number system (MDLNS), wherein the MDLNS representations of X and Y includes at least two bases B1 and B2, as follows: X=s1*(B1\hat{ }a)*(B2\hat{ }b), and Y=s2*(B1\hat{ }c)*(B2\hat{ }d). Wherein s1 and s2 are each a sign of value plus or minus one, and wherein a, b, c and d are exponents. Conditions are imposed on the exponents as follows: a, b, c and d are integers, and a is positive, b is negative, c is negative and d is positive. The representation of the sum of X+Y in the log domain is expanded as follows: log (X+Y)=log (s1*(B1\hat{ }a)*(B2\hat{ }b)+s2*(B1\hat{ }c)*(B2\hat{ }d))=log (s1*(B1\hat{ }a*B2\hat{ }d)*(B2\hat{ }(b−d)+(s2/s1)*B1\hat{ }(c−a))), wherein (b−d) is a negative exponent and (c−a) is a negative exponent.

A computer-implemented method for performing addition of real numbers represented in a multidimensional logarithmic number system (MDLNS), in accordance with one or more aspects of the present invention, includes obtaining, by program code executing on one or more processors, an instruction to sum together a first real number and a second real number. The program code represents the first and second real numbers in an MDLNS, wherein the MDLNS representation of the first and second real numbers includes the first real number represented by a first base raised to a first exponent multiplied by a second base raised to a second exponent, and the second real number represented by the first base raised to a third exponent multiplied by the second base raised to a fourth exponent. Conditions are imposed, by the program code, on the exponents, wherein the exponents are integers, and the first exponent is positive, the second exponent is negative, the third exponent is negative and the fourth exponent is positive. The program code expands an MDLNS representation of a sum of the first and second real numbers in a log domain. The program code approximates a value of a portion of the expanded MDLNS representation of the sum in a form of an approximated product term. The program code utilizes the approximated product term to simplify the MDLNS representation of the sum of the first and second real numbers. The MDLNS representation of the sum is approximated as the first base raised to a fifth integer exponent multiplied by the second base raised to a sixth integer exponent. The actual value of the sum and the approximated value of the sum are within at least 4 bits of precision or within at least 6.4 percent.

It should be appreciated that all combinations of the foregoing concepts and additional concepts discussed in greater detail below (provided such concepts are not mutually inconsistent) are contemplated as being part of the inventive subject matter disclosed herein and can be used to achieve the benefits and advantages described herein.

### DRAWINGS

The disclosure will be more fully understood from the following detailed description taken in conjunction with the accompanying drawings, in which:

FIG. 1, depicts an example of a computer-implemented method of addition of real numbers represented in a multidimensional logarithmic number system (MDLNS) according to aspects described herein;

FIG. 2 depicts an example of a continuation of the computer-implemented method of FIG. 1, according to aspects described herein;

FIG. 3 depicts an example of another continuation of the method of FIG. 1, according to aspects described herein;

FIG. 4 depicts an example of a workflow diagram that illustrates various aspects of some examples herein, according to aspects described herein; and

FIG. 5 depicts an example of a computing environment useable to perform the method of FIG. 1, according to aspects described herein.

### DETAILED DESCRIPTION

Certain examples will now be described to provide an overall understanding of the principles of the structure, function, manufacture, and use of the methods, systems, and devices disclosed herein. One or more examples are illustrated in the accompanying drawings. Those skilled in the art will understand that the methods, systems, and devices specifically described herein and illustrated in the accompanying drawings are non-limiting examples and that the scope of the present disclosure is defined solely by the claims. The features illustrated or described in connection with one example can be combined with the features of other examples. Such modifications and variations are intended to be included within the scope of the present disclosure.

The terms “significantly”, “substantially”, “approximately”, “about”, “relatively,” or other such similar terms that can be used throughout this disclosure, including the claims, are used to describe and account for small fluctuations, such as due to variations in processing from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

The examples herein include computer-implemented methods, computer program products, and computer systems that include program code (e.g., a set of one or more instructions) executing on one or more processors that executes a logarithmic data representation to simplify addition and subtraction operations. The examples herein provide significant advantages over existing approaches at least because they utilizes less memory storage. As aforementioned, the memory and storage requirements of existing approaches render these approaches unworkable given the resources of modem computing environments. representation system or method.

The examples herein significantly simplify addition and subtraction operations in the logarithmic domain over existing approaches. Hardware implementations of these methods are also significantly simplified and the power requirements for such implementations are significantly reduced. Further, as will be discussed in greater detail herein, in some examples, because the exponents a, b, c, d, x and y are integers with known signs, there is no need to use valuable storage space in a computer's memory for a sign or a floating decimal point. This advantageously and significantly reduces the storage requirements in a computer's memory for storing and manipulating the exponents compared to existing approaches.

In addition to providing significant improvements over existing approaches, the examples herein are inextricably tied to computer technology and are directed to a practical application. Applications inextricably tied to computing include digital signal processing, image compression, and seismic data processing. The backbone of these practical applications are the machinations (calculations) by one or more processors of a computing system and the computational speed and accuracy of the one or more processors in performing underlying operations to provide these types of applications. By implementing the examples described herein into a computing system, the manner in which a processor performs basic operations, such as addition and/or subtraction, is improved such that the the amount of system memory and storage utilizes by the computing system to perform these operations is significantly decreased. Thus, the examples herein are inextricably tried to computing at least because they are directed to improving the speed and accuracy of the processor(s) of the computing system. This benefit is observable in practical applications including, but not limited to digital signal processing, image compression, and seismic data processing.

### General Overview

### Logarithmic Number Systems (LNS)

For addition and/or subtraction operations performed on real numbers (e.g., X, Y) represented in a logarithmic number systems (LNS), it is helpful, if not essential, to find a suitable expansion formula for log(X+Y), in order to make the hardware implementation of such operations practical, One such well known expansion is as follows:

$$log ( X + Y ) = log ( X * ( 1 + Y / X ) ) = log ( X ) + log ( 1 + Y / X )$$

Various approaches have been suggested to approximate the function f(z)=log(1+z). Those include piece-wise linear approximations, polynomial approximations, the use of reduced-addressed look-up tables, and more. However, all of the previous methods and systems used to approximate the above function require a large amount of memory resources to accommodate, for example, large look-up tables (LUT), and/or complex hardware solutions. Further such previous methods and systems consume a significant amount of time, memory and power (see, H. Fu, 0 Mencer, W. Luk, FPGA design with optimized logarithmic arithmetic, IEEE Transactions on Computers, vo. 59, No. 7, July 2010, pp. 1000-1006, which is incorporated herein by reference in its entirety).

Since X and Y are encoded in logarithmic format, it is appropriate to re-write the above formula as follows:

$$Log ( X + Y ) = log ( 2 \hat{} a + 2 \hat{} b ) = log ( 2 \hat{} a * ( 1 + 2 \hat{} ( b - a ) ) = a + log ( 1 + 2 \hat{} ( b - a ) )$$

where X=(2\hat{ }a), Y=(2\hat{ }b) and the symbol: \hat{ } represents raising the base 2 to a power of an exponent (e.g., exponents a or b).

Note that the examples provided herein are shown as logarithms to the base 2. However, any base or bases can be used. For example, the bases of the logarithms represented herein can be 2, 3, 10, e (i.e., base of the natural log function, which substantially equals 2.718281828459), and more.

### Multidimensional Logarithmic Number Systems (MDLNS)

A general definition, used herein, for a multidimensional logarithmic number system (MDLNS) representation of a real number can be defined as follows: I. X, a real number, is equal to, or approximated by, the summation of digits from i equals 1 to d total number of digits. Wherein each digit is equal to plus or minus 1 multiplied by a product over a set of bases Bj raised to an exponent aj from j equals 1 to k total number of bases.

The representation can be represented mathematically by the following formula I:

$$X = {\sum }_{i = 1}^{d} s ( i ) {\prod }_{j = 1}^{k} Bj \hat{} aj$$

Where each “digit” equals the sign s(i) multiplied by the expression:

$${\prod }_{j = 1}^{k} Bj \hat{} aj$$

Where the symbol Π represents a product over a set of the terms Bj\hat{ }aj. The symbol \hat{ } represents raising the base Bj of each term to the power of the exponent aj of the term.

The sign s(i) of each digit is equal to plus or minus 1, the total number of digits is d, the total number of bases Bj per digit is k, and the exponents the bases are raised to are aj. Advantageously, as will be discussed in greater detail herein, in the MDLNS representations of numbers disclosed herein, the exponents, aj that each of the bases Bj are raised to can all be non-negative integers.

In applications and examples of MDLNS used herein, one or two digits are used. However, there can be any number of digits used in a MDLNS.

For purposes of clarity, the following examples of 1-digit and 2-digit MDLNS representations are provided:

### Example I

The number 100 can be written several different ways in a 2-digit, 2-base MDLNS format as follows:

$$A . 100 = + {2}^{5} {3}^{1} + {2}^{2} {3}^{0} ,$$

$$B . 100 = + {2}^{6} {3}^{0} + {2}^{2} {3}^{2} ,$$

$$C . 100 = + {2}^{2} {3}^{3} - {2}^{3} {3}^{0} .$$

The above examples are error-free representations of the number 100 in 2-digit MDLNS with bases (2,3), wherein d=2, k=2, B₁=2, B₂=3 and the signs are showcased directly in the description.

### Example II

The number 100 can also be written several different ways in a single digit (1-digit), 2-base MDLNS format. However, in the case of bases (2,3), the number 100 must be approximated into the form 2\hat{ }a*3\hat{ }b. Such an approximation can be achieved with any prescribed precision if we increase the sizes of the exponents. This claim stems from the fundamental number theoretic result that the set of real numbers of the form a+b*z (a,b —integers,z—irrational) is dense over the real line. In the case of 100, a very good approximation is 2⁻⁵²3³⁷, which is equal to 99.9831199.

Numbers of a MDLNS are often encoded as a vector of its exponents. So, in the case of the 1-digit, 2-base MDLNS (Example II): 100 can be approximated as (1, −52, 37), wherein the first component is the sign and the second and third components are the exponents that the bases 2 and 3 are raised to respectively. In the case of the 2-digit MDLNS (Example I): 100 can be exactly represented as follows:

### Example I. A: (1,5,1,1,2,0)

### Example I. B: (1,6,0,1,2,2), and

### Example I. C: (1,2,3,−1,3,0)

wherein the first and the fourth components are signs, the second and third components are the exponents that the bases 2 and 3 are raised to respectively for the first digit, and the fifth and sixth components are the exponents that the bases 2 and 3 are raised to respectively for the second digit.

It is important to note that 1-digit representations are computationally simpler and lead to simplified architectures than that of 2-digit representations. On the other hand, the use of 2-digit representations allow extremely good accuracy with significantly smaller exponents compared to 1-digit representations.

It is also important to note that using two or more bases to represent a number, provides a user with a degree of control of the sign of the exponents associated with each base. This is because the number represented is the product of two terms (a base raised to a power of an exponent), and there are any number of term values that can be multiplied together to obtain or approximate the number represented. For example, in the case of single digit, two base (2, 3) MDLNS representing the number 100. The number 100 can be approximated as:
100≈2⁻⁵²3³⁷=99.9831199, wherein the base 2 exponent is negative and the base 3 exponent is positive; or
100≈2⁻⁵² 3⁻⁴=101.13, wherein the base 2 exponent is positive and the base 3 exponent is negative.

As will be explained in greater detail herein, this ability to control the sign of the exponents in a two or more base MDLNS can be advantageously utilized in the novel methods described herein of computer implemented addition of numbers represented in such a multidimensional logarithmic number system. Additionally, specific mathematical and algorithmic details about multidimensional logarithmic number systems (MDLNS) can be found in V.Dimitrov et al. “Multiple base number systems—theory and applications”, CRC Press, 2012, which is incorporated herein in its entirety.

### Comparison Between Classical LNS and MDLNS

Classical logarithmic number systems (LNS) can be viewed as a special case of a MDLNS wherein a) there is only one digit; b) there is only one base and c) the exponents can be defined as real (fixed or floating point numbers).

In both number systems —LNS and MDLNS —the multiplication procedure is converted into addition; the division is converted into subtraction and the square root is converted into bit shifts. Table 2 below provides a comparison of some of the main operations in both LNS and MDLNS:

TABLE 2
Conceptual complexity comparison of different
operations in logarithmic-based number systems

| Arithmetic operation in | | |
|---|---|---|
| logarithmic | | |
| representations (LNS and | | |
| MDLNS) | Difficulty level | Implementation |
| Square root, inversion | The easiest | 1-bit shift to the right (for |
| | | square root |
| | | implementation); change |
| | | of the sign bit (for |
| | | inversion implementation) |
| Multiplication, Division | Easy | Addition (for |
| | | multiplication |
| | | implementation); |
| | | Subtraction (for division |
| | | implementation) |
| Addition, Subtraction | Most difficult | Both operations are |
| | | converted into |
| | | additions/subtractions and |
| | | look-up table operations |

The above Table 2 showcases the similarities between LNS and MDLNS. The main differences are in the details associated with the specific implementation of the arithmetic operations. Table 3 below provides a summary of some of those differences:

TABLE 3
Comparison between LNS and MDLNS

| | Implementation | Implementation | |
|---|---|---|---|
| | in LNS | in MDLNS | Winner |
| Inversion | Change of the sign | Change of sign | Tie |
| Square root | Bit-shift | Bit-shift and | LNS |
| | | conditional | |
| | | addition | |
| Multiplication | n-bit adders | n/2-bit adders | MDLNS |
| Division | n-bit adders | n/2-bit adders | MDLNS |
| Add/Sub | n-bit adders | n/2-bit adders | MDLNS |
| | and LUT | and LUT of | |
| | of size 2ⁿ | size 2^{n/2} | |

Logarithmic Number System Addition-Main Issue

As outlined previously the basics of addition in a logarithmic number system (LNS) involve the conversion of Log (X+Y), which in the log to the base 2 system, can be rewritten as:

$$2 \hat{} a + 2 \hat{} b = 2 \hat{} a ( 1 + 2 \hat{} ( b - a ) ) = 2 \hat{} a * 2 \hat{} x = 2 \hat{} ( a + x ) , wherein$$

$$X = 2 \hat{} a and Y = 2 \hat{} b .$$

The most problematic and time-consuming part of the above conversion is the implementation of the transformation of 1+2\hat{ }(b−a) to 2\hat{ }x, which is typically implemented with a look-up table containing the precomputed values of the function f(y)=1+2\hat{ }y in logarithmic format. It is the large size of those LUTs that prevents the use of logarithmic number systems in much broader spectrum of applications. The size of the LUTs is an exponential function of 2\hat{ }y. By contrast, the size of the LUT in the MDLNS described herein is an exponential function of 2\hat{ }(y/2). Accordingly, the LUT in an MDLNS are advantageously smaller and require less memory than in an LNS. All the variables used in this transformation —a, b, x, y —can be floating point numbers.

### Novel Algorithms for MDLNS Addition

For purposes of simplification, in the following examples of MDLNS representations, only two dimensional logarithmic number systems (2DLNS) with two bases (B1, B2) and a single-digit will be considered. In such a 2DLNS, representation of two real numbers X and Y can be written in the following form:

$$X = s 1 * ( B 1 \hat{} a ) ( B 2 \hat{} b )$$

$$Y = s 2 * ( B 1 \hat{} c ) ( B 2 \hat{} d )$$

Wherein, s1 and s2 are the signs; B1 and B2 are the bases; and a, b, c and d are the exponents.

Accordingly, the addition of the two real numbers in the 2DLNS can be written as:

$$log ( X + Y ) = log ( s 1 * ( B 1 \hat{} a ) ( B 2 \hat{} b ) + s 2 * ( B 1 \hat{} c ) ( B 2 \hat{} d ) )$$

The selection of the exponents (e.g., a,b,c,d) can be done to ensure that the following approximations of X, Y and other terms satisfy a specific error condition. In machine learning applications a typical requirement is that the error of approximation must be less than or equal to an absolute value of 2\hat{ }(−9) multiplied by the exact value of the term to be approximated or 1/512 (about 0.002) multiplied by the exact value of the term to be approximated, which is defined herein as 9 bits of precision. By this definition, a 9 bit precision error approximation will be within about 0.2 percent (i.e., (1/512)*100=about 0.2) of the exact value of the term to be approximated.

Additionally, the exponents (e.g., a, b. c. d) can be selected such that the error approximation between the exact value of a term (such as X+Y) and the approximate value of the term can be less than or equal to 8 bits of precision (i.e., an absolute value of 2\hat{ }(−8) or 1/256 multiplied by the exact value). Accordingly, an 8 bit precision error approximation will be within about 0.4 percent (i.e., (1/256)*100=about 0.4) of the exact value of the term.

Additionally, the exponents (e.g., a, b. c. d) can be selected such that the error approximation between the exact value of a term (such as X+Y) and the approximate value of the term can be less than or equal to 7 bits of precision (i.e., an absolute value of 2\hat{ }(−7) or 1/128 multiplied by the exact value). Accordingly, a 7 bit precision error approximation will be within about 0.8 percent (i.e., (1/128)*100=about 0.8) of the exact value of the term.

Additionally, the exponents (e.g., a, b. c. d) can be selected such that the error approximation between the exact value of a term (such as X+Y) and the approximate value of the term can be less than or equal to 6 bits of precision (i.e., an absolute value of 2\hat{ }(−6) or 1/64 multiplied by the exact value). Accordingly, a 6 bit precision error approximation will be within about 1.6 percent (i.e., (1/64)*100=about 1.6) of the exact value of the term.

Additionally, the exponents (e.g., a, b. c. d) can be selected such that the error approximation between the exact value of a term (such as X+Y) and the approximate value of the term can be less than or equal to 5 bits of precision (i.e., an absolute value of 2\hat{ }(−5) or 1/32 multiplied by the exact value). Accordingly, a 5 bit precision error approximation will be within about 3.2 percent (i.e., (1/32)*100=about 3.2) of the exact value of the term.

Additionally, the exponents (e.g., a, b. c. d) can be selected such that the error approximation between the exact value of a term (such as X+Y) and the approximate value of the term can be less than or equal to 4 bits of precision (i.e., an absolute value of 2\hat{ }(−4) or 1/16 multiplied by the exact value). Accordingly, a 4 bit precision error approximation will be within about 6.4 percent (i.e., (1/256)*100=about 6.4) of the exact value of the term.

By way of contrast, in a classical LNS with a single base B1 and a single digit, the addition of the same two real numbers can be written as: Log (X+Y)=log (s1*(B1\hat{ }a)+s2(B1\hat{ }b). Also as discussed earlier, the function log(X+Y) in a classical LNS is commonly expanded as follows: log (X+Y)=log (X*(1+Y/X))=log (X)+log (1+Y/X)=log (s1*B1\hat{ }a)+log (1+(s2/s1)*B1\hat{ }(b-a)). However, there is still a need for a good and fast way to approximate the function log (1+Y/X) in a classical LNS.

Advantageously, one of the main advantages of an MDLNS encoding as compared to the classical LNS is the freedom to choose the sign of the exponents depending on the specific hardware needs. Therefore, a first condition can be imposed on the signs of the exponents that: a is positive, b is negative, c is negative and d is positive.

Also advantageously, a second condition can be imposed on the exponents that the exponents are integers. The reason the second condition can also be imposed is based on the theorem that: if γ is irrational, then the set of numbers a+bγ, wherein a and b are integers, is dense over the set of reals. The meaning of this theorem is that in ANY interval over the real line, e.g. [z1,z2], wherein z1 and z2 are real numbers and z2 >z1, one can find infinitely many numbers of the form a +by, wherein a and b are integers. That guarantees —mathematically —that one can obtain an arbitrary accurate approximation of any real numbers of that form. This is an essential difference between the classical 1-D LNS and an MDLNS encoding.

More specifically, the classical LNS requires conversion of floating point numbers from linear to logarithmic domain, that is —mapping one floating point number to another. In sharp contrast, in MDLNS one maps floating point numbers in a vector of small integer exponents. The fact that within the MDLNS domain all computations can be performed over integers is a major advantage over classical LNS for at least two major reasons: 1) the computations with the exponents can be done in independent, parallel manner and 2) the use of pure integer arithmetic always leads to considerably more power efficient hardware designs and requires less memory.

The use of purely integer exponents allows one to use fixed-point adders, instead of floating-point adders, which is known to be much more efficient in terms of power consumption: (see, H. Fu, O. Mencer, W. Luk, FPGA design of optimized logarithmic arithmetic, IEEE Transactions on Computers, vol. 59, No. 7, July 2010, pp. 1000-1006).

Accordingly, by imposing at least the first condition (i.e., that a is positive, b is negative, c is negative and d is positive) above, the sum of X+Y in the 2DLNS log domain can be expanded in the following novel form:

| | |
|---|---|
| i. | log (X+Y) = log (s1*(B1\hat{ }a)*(B2\hat{ }b) + s2*(B1\hat{ }c)*(B2\hat{ }d)) = |
| ii. | log (s1*(B1\hat{ }a*B2\hat{ }d)*(B2\hat{ }(b−d) + (s2/s1)*B1\hat{ }(c−a))). |

It is important to note that in the above expansion, (b−d) is a negative exponent and (c−a) is also a negative exponent as a result of imposing the first condition that a is positive, b is negative, c is negative and d is positive. Therefore, this makes the sum term B2\hat{ }(b−d)+(s2/s1)*B1\hat{ }(c−a) small. For many applications, for example machine learning applications, it is preferable that the sum term be less than 1, or less than 1/2, or less than 1/4, or less than 1/8.

The small sizes of this sum advantageously provides the feature that only real numbers belonging to this interval have to be stored in the LUT, which can reduce the size of those LUT by a factor of 8 for applications such as machine learning applications. The sum term can be accurately approximated in the form of a product term s3*(B1\hat{ }x)*(B2*y), wherein s3 is the sign and x and y are small exponents for the degree of accuracy attained. For example, the degree of accuracy can be within 8-bits of precision or within an absolute value of 1/256.

Moreover, because the sum term of B2\hat{ }(b−d)+(s2/s1)*B1 \hat{ }(c−a) is small, so too is the look-up table required to estimate the produce term of s3*(B1\hat{ }x)*(B2*y). Accordingly, the memory required to store such a look-up table can be significantly reduced. For example, the LUT can be reduced by a factor of 8 for many applications, including machine learning applications.

The approximated product term can then be substituted for the sum term to obtain an accurate approximation of X+Y as follows:

| | |
|---|---|
| i. | log (X+Y) = log (s1*(B1\hat{ }a*B2\hat{ }d)*(B2\hat{ }(b−d) + |
| | (s2/s1)*B1\hat{ }(c−a))), which can be approximated as : |
| ii. | log (s1*(B1\hat{ }a*B2\hat{ }d)* s3*(B1\hat{ }x)*(B2\hat{ }y)) within at least 4 |
| | bits of precision or within at least 6.4 percent = |
| iii. | log ((s1*s3)*(B1\hat{ }(a+x))*(B2\hat{ }(d+y))), |
| iv. | wherein X+Y= (s1*s3)*(B1\hat{ }(a+x))*(B2\hat{ }(d+y)) |
| | within at least 4 bits of precision or within at |
| | least 6.4 percent. |

Because the signs of the exponents a, b, c, d, x and y are known, there is no need to use valuable storage space in a computer's memory for a sign. This advantageously and significantly further reduces the storage requirements in a computer's memory for storing and manipulating the exponents compared to prior art systems. Additionally, if the second condition that the exponents also be integers is imposed, then there is no need to use valuable storage space for a floating point decimal.

If the first condition on the signs of the exponents cannot be met, then the signs can be manipulated using a good approximation of unity (1). For example, if initially the sign of the exponent a is negative, rather than positive, and the sign of the exponent b is positive, rather than negative, then the signs can be manipulated by obtaining an approximate value of 1 represented in the MDLNS as follows: 1=(B1\hat{ }e)*(B2\hat{ }f) within at least 4 bits of precision or within at least 6.4 percent. Wherein e is a positive exponent having an absolute value greater than a, and wherein f is a negative exponent having an absolute value greater than b. Then the expression (B1\hat{ }a)*(B2\hat{ }b) can be multiplied and manipulated by the approximate value of 1 as follows: (B1\hat{ }a)*(B2\hat{ }B)*(B1\hat{ }e)*(B2\hat{ }f)=B1\hat{ }(a+e)*B2\hat{ }(b+f))=(B1\hat{ }a)*(B2\hat{ }b) within at least 4 bits of precision or within at least 6.4 percent. Wherein (a+e) is driven positive due to the higher absolute value of e with respect to a, and (b+f) is driven negative due to the higher absolute value of f with respect to b.

Also by way of example, if initially the sign of the exponent c is positive, rather than negative, and the sign of the exponent d is negative, rather than positive, then the signs can be manipulated by obtaining an approximate value of 1 represented in the MDLNS as follows: 1=(B1\hat{ }e)*(B2\hat{ }f) within at least 4 bits of precision or within at least 6.4 percent. Wherein e is a negative exponent having an absolute value greater than c, and wherein f is a positive exponent having an absolute value greater than d. Then the expression (B1\hat{ }c)*(B2\hat{ }d) can be multiplied and manipulated by the approximate value of 1 as follows: (B1\hat{ }c)*(B2\hat{ }d)*(B1\hat{ }e)*(B2\hat{ }f)=B1\hat{ }(c+e)*B2\hat{ }(d+f))=(B1\hat{ }c)*(B2\hat{ }d) within at least 4 bits of precision or within at least 6.4 percent. Wherein (c+e) is driven negative due to the higher absolute value of e with respect to c, and (d+f) is driven positive due to the higher absolute value of f with respect to d.

### Numerical Examples

By way of the following examples, it is assumed that B1=2 and B2=3 and that signs s1, s2 and s3 are 1. Therefore, the above novel expansion of log (X+Y) can be written as follows:

### Example 1

| | |
|---|---|
| i. | log (X+Y) = |
| ii. | log ((2\hat{ }a)*(3\hat{ }b) + (2\hat{ }c)*(3\hat{ }d)) = |
| iii. | log ((2\hat{ }a*3\hat{ }d)*(3\hat{ }(b−d) + 2\hat{ }(c−a))), which |
| | can be approximated as: |
| iv. | log ((2\hat{ }a*3\hat{ }d)* (2\hat{ }x)*(3\hat{ }y)) within at least 4 bits |
| | of precision or within at least 6.4 percent = |
| v. | log ((2\hat{ }(a+x))*(3\hat{ }(d+y))), |
| vi. | wherein X+Y ≈ (2\hat{ }(a+x))*(3\hat{ }(d+y)) within |
| | at least 4 bits of precision or within at least |
| | 6.4 percent. |

### Example 2

log(X+Y)= i.

log ((2\hat{ }a)*(3\hat{ }b)+(2\hat{ }c)*(3\hat{ }d)) ii.

Assume in this example that c is 8 (positive, rather than negative), and d is −6 (negative, rather than positive). Therefore Y=2\hat{ }*3\hat{ }(−6)=0.351166.

However, for the expansion of log(X+Y) it is desirable to convert the sign of exponent c to a negative value and the sign of exponent d to a positive value. This can be done with a good approximation of 1, such as for example: 1≈2\hat{ }(−19)*3\hat{ }(12)=1.01364. Note that the actual value of 1 and the approximate value of 1.01364, differ by only an absolute value of 0.01364, which is within 6 bits of precision or within 1/64=0.015625.

Therefore, by multiplying Y by the approximation of 1, you get:

$$Y = ( 2 \hat{} c ) * ( 3 \hat{} d ) = 2 \hat{} 8 * 3 \hat{} ( - 6 ) \approx 2 \hat{} 8 * 3 \hat{} ( - 6 ) * 2 \hat{} ( - 19 ) * 3 \hat{} ( 12 ) = 2 \hat{} ( 8 - 19 ) * 3 \hat{} ( - 6 + 12 ) = 2 \hat{} ( - 11 ) * 3 \hat{} ( 6 ) .$$

Therefore, c and d can be approximated as c≈−11 when d≈6.

By comparison:
Y=0.351166 and 2\hat{ }(−11)*3\hat{ }(6)=0.356, wherein the two values of Y agree within 1.4 percent or within 7 bits of precision.

### Example 3

Assume X=2\hat{ }a*3=2\hat{ }*3\hat{ }(−6) and Y=2\hat{ }c*3\hat{ }d=2\hat{ }(−11)*3\hat{ }4, wherein a=7, b=(−6), c=(−11) and d=4. Accordingly, the signs of the exponents are in the desired order for the novel expansion as follows:

| | |
|---|---|
| i. | log (X+Y) = |
| ii. | log ((2\hat{ }a)*(3\hat{ }b) + (2\hat{ }c)*(3\hat{ }d)) = |
| iii. | log ((2\hat{ }a*3\hat{ }d)*(3\hat{ }(b−d) + 2\hat{ }(c−a)))= |
| iv. | log ((2\hat{ }7*3\hat{ }4)*(3(−6−4) + 2\hat{ }(−11−7)))= |
| v. | log ((2\hat{ }7*3\hat{ }4)*(3\hat{ }(−10) + 2\hat{ }(−18)))= |

Again, because the exponents −10 and −18 are negative, then the function 3\hat{ }(−10)+2\hat{ }(−18) will be small and easily and accurately approximated in the form of 2\hat{ }x*3\hat{ }y. Accordingly, using a look-up table, the function of 3\hat{ }(−10)+2\hat{ }(−18), which equals 0.0000207, can be approximated as 2\hat{ }(−14)*3\hat{ }(−1), which equals 0.0000204. Therefore:

| | |
|---|---|
| i. | log ((2\hat{ }7*3\hat{ }4)*(3\hat{ }(−10) + 2\hat{ }(−18))), which |
| | can be approximated as: |
| ii. | log (2\hat{ }7*3\hat{ }4*(2\hat{ }(−14)*3\hat{ }(−1) within at least |
| | 4 bits of precision or within at least 6.4 |
| | percent = |
| iii. | log (2\hat{ }(−7)*3\hat{ }3) = |
| iv. | log (0.211) |

Accordingly, X+Y should equal approximately 0.211.

To check this result, it can be seen from the above equations that log(X+Y) is exactly equal to log ((2\hat{ }7*3\hat{ }4)*(3\hat{ }(−10)+2\hat{ }(−18)). Therefore X+Y is exactly equal to (2\hat{ }7*3\hat{ }4)*(3\hat{ }(−10)+2\hat{ }(−18), which equals 0.215.

Accordingly, X+Y=0.215≈0.211. Therefore, the exact value of X+Y and the approximate value of X+Y agree within 2 percent or within 7 bits of precision.

### Referring to the FIGS.

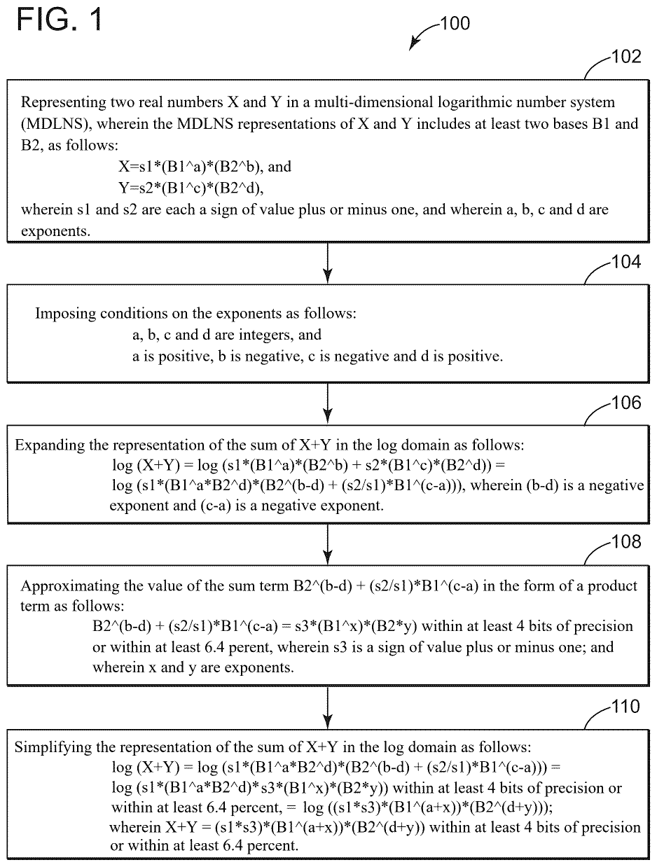

Referring to FIG. 1, an example is depicted of a computer-implemented method 100 of addition of real numbers represented in a multidimensional logarithmic number system (MDLNS) according to aspects described herein. The MDLNS represents real numbers in the format of a single digit and two bases.

The method can be implemented in a computer system, which includes a memory and one or more processors in electronic communication with the memory. An algorithm can be stored in the memory as a set of instructions for execution by the one or more processors.

The method can also be stored in a computer program product. The computer program product can include at least one non-transitory computer readable storage medium. The storage medium can store instructions, for execution by a processor, to perform the method.

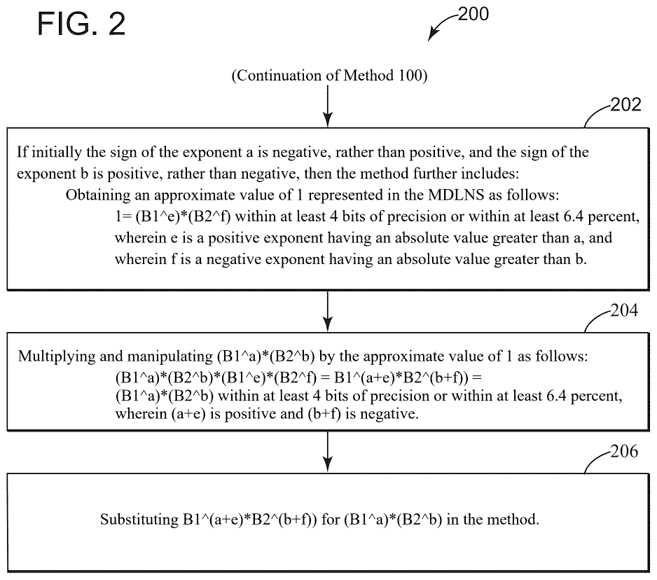

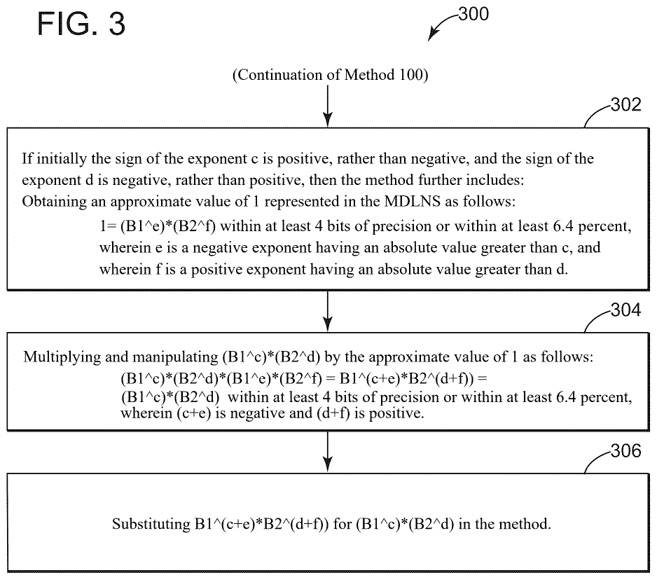

FIG. 1 illustrates program code executing on one or more processors receiving an instruction to perform a mathematical operation which can be part of a process such as digital signal processing. Specifically, FIG. 1 illustrates program code in examples herein adding real numbers represented in an MDLNS. As aforementioned, digital signal processing is just one example of a process which could include the underlying calculation being performed by the program code in the example herein utilizing the approach disclosed. In this example, program code executing on one or more processors receives an instruction to add two number, X and Y. FIGS. 2 and 3 represent additional operations performed by the program code in examples herein when the program code determined that the result of earlier calculations meet certain criteria. Both FIGS. 2 and 3 represent calculations the program code can perform with a result produced by the process illustrated in FIG. 1 when that result meets certain criteria.

Based on obtaining this instruction and the two real numbers, (e.g., X and Y), as inputs, and the instruction to add the numbers, the program code in the examples herein converts X and Y into MDLNS representations of X and Y, which include at least two bases B1 and B2, as follows:

| | |
|---|---|
| i. | X=s1*(B1\hat{ }a)*(B2\hat{ }b), and |
| ii. | Y=s2*(B1\hat{ }c)*(B2\hat{ }d). |

Wherein, s1 and s2 are each a sign of value plus or minus one, and a, b, c and d are exponents (102).

The exponents a, b, c, d, x and y can each have an absolute value that is less than or equal to 63, which can be stored in a computer's memory as 5 binary bits. Additionally, the exponents can have an absolute value that is less than or equal to 31 (storable as 4 bits), or less than or equal to 15 (storable as 3 bits). The exponents can also be integers, wherein no memory is needed for the storage of a decimal point.

The program code imposes the following conditions on the exponents:
i. a, b, c and d are integers, and
ii. a is positive, b is negative, c is negative and d is positive (104).

As aforementioned, the examples herein provide significant improvements over existing approaches in part because implementing the examples herein reduces memory utilized in these mathematical operations. As illustrated in FIG. 1, the program code imposing the sign conditions on the exponents eliminates the need for memory storage of the sign. Additionally, the program code imposing the condition that the exponents are integers, eliminates the need for memory storage of the decimal point.

In examples where the mathematical operation is to add the number X and Y together, as illustrated in FIG. 1, the program code expands the representation of the sum of X+Y in the log domain as follows:

| | |
|---|---|
| I. | log (X+Y) = log (s1*(B1\hat{ }a)*(B2\hat{ }b) + s2*(B1\hat{ }c)*(B2\hat{ }d)) = |
| II. | log (s1*(B1\hat{ }a*B2\hat{ }d)*(B2\hat{ }(b−d) + (s2/s1)*B1\hat{ }(c−a))). |

Wherein (b−d) is a negative exponent and (c−a) is a negative exponent (106).

The program code approximates the value of the sum term B2\hat{ }(b−d)+(s2/s1)*B1\hat{ }(c−a) in the form of a product term as follows: B2\hat{ }(b−d)+(s2/s1)*B1\hat{ }(c−a)=s3*(B1\hat{ }x)*(B2*y) within at least 4 bits of precision or within at least 6.4 percent. Wherein s3 is a sign of value plus or minus one, and wherein x and y are exponents (108).

In various examples, the value of the sum term B2\hat{ }(b−d)+(s2/s1)*B1\hat{ }(c−a) can be within plus or minus three percent of the value of the approximated product term s3*(B1\hat{ }x)*(B2*y) or can be within at least 4 bits of precision or within at least 6.4 percent of the approximated product term s3*(B1\hat{ }x)*(B2*y). Additionally, the sum term can be within plus or minus 2 percent, or 1 percent, of the value of the product term. s3*(B1\hat{ }x)*(B2*y) can be obtained from a look-up table.

The program code simplifies the representation of the sum of X+Y in the log domain is simplified as follows:

| | |
|---|---|
| i. | log (X+Y) = log (s1*(B1\hat{ }a*B2\hat{ }d)*(B2\hat{ }(b−d) + (s2/s1)*B1\hat{ }(c−a))), which can be |
| | approximated as: |
| ii. | log (s1*(B1\hat{ }a*B2\hat{ }d)* s3*(B1\hat{ }x)*(B2*y)) within at least 4 bits of |
| | precision or within at least 6.4 percent = |
| iii. | log ((s1*s3)*(B1\hat{ }(a+x))*(B2\hat{ }(d+y))) (110). |

The program code thus determines that X+Y=(s1*s3)*(B1\hat{ }(a+x))*(B2\hat{ }(d+y)) within at least 4 bits of precision or within at least 6.4 percent.

At the termination of FIG. 1, in some situations, the program code has produced a result. The result, the sum of X and Y, can then be utilized by the process for which this was an underlying calculation. However, if initially the sign of the exponent a is negative, rather than positive, and the sign of the exponent b is positive, rather than negative, then the program code can complete additional calculations before providing a result. This circumstance is illustrated in FIG. 2. Referring to FIG. 2, an example is depicted of a continuation 200 of the computer-implemented method 100 of addition of real numbers represented in an MDLNS, according to aspects described herein. The method can continue as follows:

Based on the program code determining that if initially the sign of the exponent a is negative, rather than positive, and the sign of the exponent b is positive, rather than negative, then the method further, the program code obtains an approximate value of 1 represented in the MDLNS in the following form:
1=(B1\hat{ }e)*(B2\hat{ }f) within at least 4 bits of precision or within at least 6.4 percent,

Wherein e is a positive exponent having an absolute value greater than a, and wherein f is a negative exponent having an absolute value greater than b (202).

The exponents e and f each can be integers. Additionally, exponent e and f can have an absolute value of less than or equal to 63, less than or equal to 31 or less than or equal to 15. Moreover, the absolute value of the term (B1\hat{ }e)*(B2\hat{ }f) can be within a range of 1 plus or minus 0.03 or 0.02 or 0.01.

The program code multiples and manipulates the expression (B1\hat{ }a)*(B2\hat{ }b) by the approximate value of 1 as follows: (B1\hat{ }a)*(B2\hat{ }b)*(B1\hat{ }e)*(B2\hat{ }f)=B1\hat{ }(a+e)*B2\hat{ }(b+f))=(B1\hat{ }a)*(B2\hat{ }b) within at least 4 bits of precision or within at least 6.4 percent. Wherein (a+e) is positive and (b+f) is negative (204).

The program code substitutes B1\hat{ }(a+e)*B2\hat{ }(b+f)) for (B1\hat{ }a)*(B2\hat{ }b) (206).

As aforementioned, FIG. 3 illustrates additional activities of the program code (executed by the one or more processors) when the result of the process in FIG. 1 meets certain criteria. The process does not terminate at FIG. 1 and the program code continues to performs the workflow 300 illustrates in FIG. 3 if the program code determines that (initially) the sign of the exponent c is positive, rather than negative, and the sign of the exponent d is negative, rather than positive. Referring to FIG. 3, based on determining that initially the sign of the exponent c is positive, rather than negative, and the sign of the exponent d is negative, rather than positive, the program code approximates a value of 1 represented in the MDLNS in the following form:
1=(B1\hat{ }e)*(B2\hat{ }f) within at least 4 bits of precision or within at least 6.4 percent,

Wherein e is a negative exponent having an absolute value greater than c, and wherein f is a positive exponent having an absolute value greater than d (302).

The exponents e and f each can be integers. Additionally, exponent e and f can have an absolute value of less than or equal to 63, less than or equal to 31 or less than or equal to 15. Moreover, the absolute value of the term (B1\hat{ }e)*(B2\hat{ }f) can be within a range of 1 plus or minus 0.03 or 0.02 or 0.01.

The program code multiples and manipulates the expression (B1\hat{ }c)*(B2\hat{ }d) by the approximate value of 1 as follows: (B1\hat{ }c)*(B2\hat{ }d)*(B1\hat{ }e)*(B2\hat{ }f)=B1\hat{ }(c+e)*B2\hat{ }(d+f))=(B1\hat{ }c)*(B2\hat{ }d) within at least 4 bits of precision or within at least 6.4 percent. Wherein (c+e) is negative and (d+f) is positive (304).

The program code substitutes B1\hat{ }(c+e)*B2\hat{ }(d+f)) for (B1\hat{ }c)*(B2\hat{ }d) in the method.

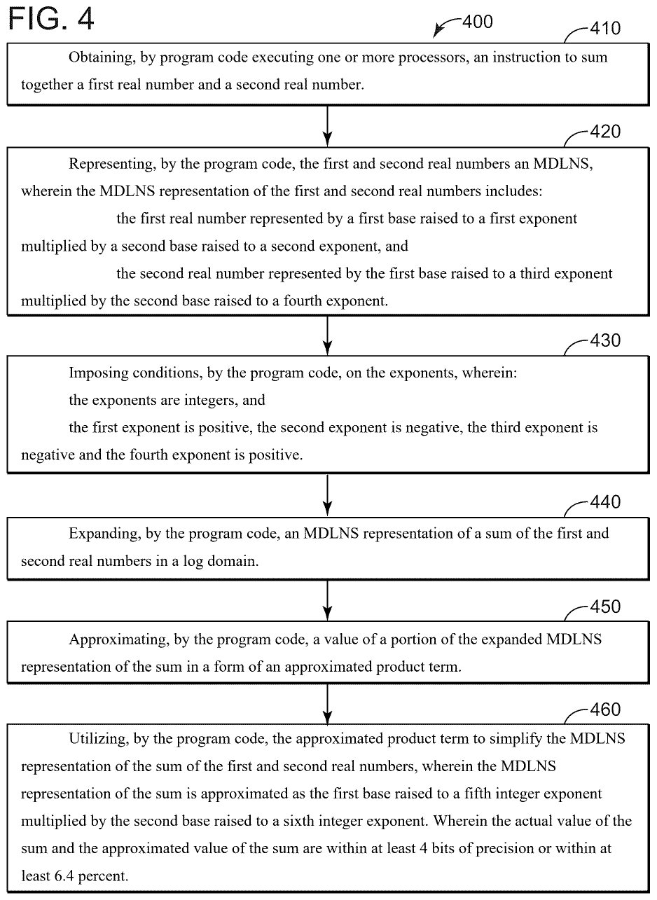

Referring to FIG. 4, a workflow diagram 400 is depicted that illustrates various aspects of some examples herein. As illustrated in FIG. 4, program code executing on one or more processors obtains an instruction to sum together a first real number and a second real number. (410).

At 420, the first and second real numbers are represented, by the program code, in an MDLNS, wherein the MDLNS representation of the first and second real numbers includes:
the first real number represented by a first base raised to a first exponent multiplied by a second base raised to a second exponent, and
the second real number represented by the first base raised to a third exponent multiplied by the second base raised to a fourth exponent.

At 430, conditions are imposed, by the program code, on the exponents, wherein: the exponents are integers, and
the first exponent is positive, the second exponent is negative, the third exponent is negative and the fourth exponent is positive.

At 440, an MDLNS representation of a sum of the first and second real numbers is expanded, by the program code, in a log domain.

At 450, A value of a portion of the expanded MDLNS representation of the sum is expanded, by the program code, in a form of an approximated product term.

At 460, the approximated product term is utilized, by the program code, to simplify the MDLNS representation of the sum of the first and second real numbers. Wherein the MDLNS representation of the sum is approximated as the first base raised to a fifth integer exponent multiplied by the second base raised to a sixth integer exponent. Wherein the actual value of the sum and the approximated value of the sum are within at least 4 bits of precision or within at least 6.4 percent.

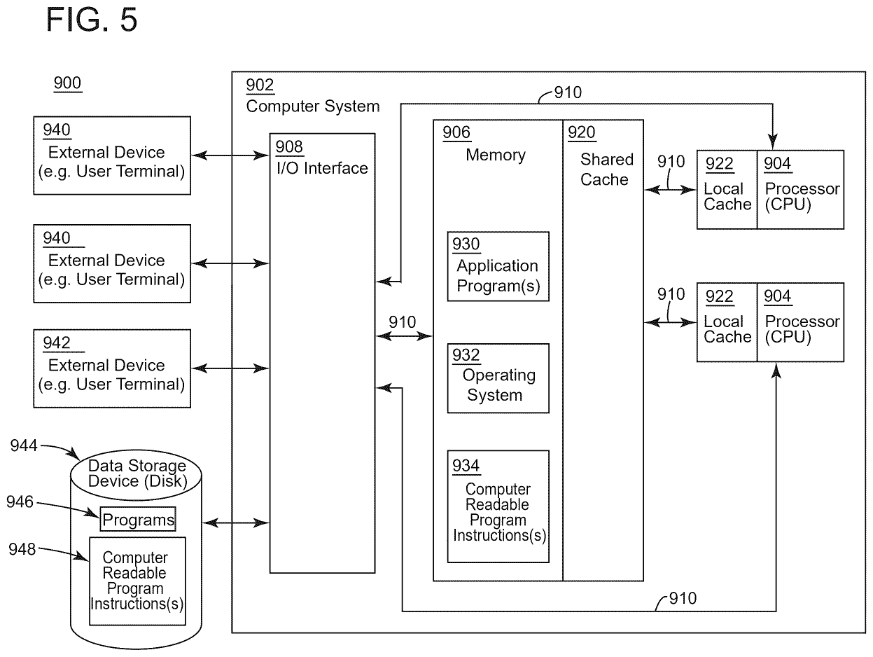

Referring to FIG. 5, a computing environment 900 useable to perform the process and/or method of this invention is disclosed. The computing environment includes, for instance, a computer system 902 shown, e.g., in the form of a general-purpose computing device. Computer system 902 can include, but is not limited to, one or more processors or processing units 904 (e.g., central processing units (CPUs)), a memory 906 (a.k.a., system memory, main memory, main storage, central storage or storage, as examples), and one or more input/output (I/O) interfaces 908, coupled to one another via one or more buses and/or other connections 910.

Bus 910 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 906 can include, for instance, a cache 920, such as a shared cache, which can be coupled to local caches 922 of processors 904. Further, memory 906 can include one or more programs or applications 930, an operating system 932, and one or more computer readable program instructions 934. Computer readable program instructions 934 can be configured to carry out functions of embodiments of aspects of the invention.

Computer system 902 can also communicate via, e.g., I/O interfaces 908 with one or more external devices 940, one or more network interfaces 942, and/or one or more data storage devices 944. Example external devices include a user terminal, a tape drive, a pointing device, a display, etc. Network interface 942 enables computer system 902 to communicate with one or more networks, such as a local area network (LAN), a general wide area network (WAN), and/or a public network (e.g., the Internet), providing communication with other computer devices or systems. For example, the system can be connected to a personal computer, tablet device or smart phone to communicate the assigned or unassigned status of mobile objects to user via a graphical user interface.

Data storage device 944 can store one or more programs 946, one or more computer readable program instructions 948, and/or data, etc. The computer readable program instructions can be configured to carry out functions of embodiments of aspects of the invention.

Computer system 902 can include and/or be coupled to removable/non-removable, volatile/non-volatile computer system storage media. For example, it can include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with computer system 902. Examples, include, but are not limited to: microcode, device drivers, redundant processing units, external disk drive arrays, RAID systems, tape drives, and data archival storage systems, etc.

Computer system 902 can be operational with numerous other general purposes or special purpose computing system environments or configurations. Examples of well-known computing systems, environments, and/or configurations that can be suitable for use with computer system 902 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

One or more of the processors and/or other aspects of the computer system or computing environment can be remote from the mobile object. Further, in one particular example, a processor, such as processor 904, can execute, in accordance with one or more aspects of the present invention, one or more machine learning engines and/or other engines to provide, based on training and learning, an optimal travel route or path for mobile object. These engines can be stored in memory, including main memory and/or one or more caches, and/or external storage, and can be executed on one or more processors. Many variations exist.

One or more aspects can relate to cloud computing. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

Aspects of the present invention can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages such as Angular, HTML, CSS, .NET Framework, C# and Microsoft SQL Server, and including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects can be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider can receive payment from the customer under a subscription and/or fee agreement, as examples. Additionally or alternatively, the service provider can receive payment from the sale of advertising content to one or more third parties.

In one aspect, an application can be deployed for performing one or more embodiments. As one example, the deploying of an application comprises providing computer infrastructure operable to perform one or more embodiments.

As a further aspect, a computing infrastructure can be deployed comprising integrating computer readable code into a computing system, in which the code in combination with the computing system is capable of performing one or more embodiments.

As yet a further aspect, a process for integrating computing infrastructure comprising integrating computer readable code into a computer system can be provided. The computer system comprises a computer readable medium, in which the computer medium comprises one or more embodiments. The code in combination with the computer system is capable of performing one or more embodiments.

Although various embodiments are described above, these are only examples. For example, different types of unmanned aerial vehicles can be used, as well as other types of neural networks and/or evolutionary algorithms. Many variations are possible.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters can also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

It should be appreciated that all combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Although the invention has been described by reference to specific examples, it should be understood that numerous changes can be made within the spirit and scope of the inventive concepts described. Accordingly, it is intended that the disclosure not be limited to the described examples, but that it have the full scope defined by the language of the following claims.

What is claimed is:

1. A computer-implemented method for performing addition of real numbers represented in a multidimensional logarithmic number system (MDLNS), the method comprising:
obtaining, by one or more processors, an instruction to add two real numbers X and Y;
representing, by the one or more processors, the two real numbers in an MDLNS, wherein the MDLNS representations of X and Y includes at least two bases B1 and B2, as follows:
X=s1*(B1\hat{ }a)*(B2\hat{ }b), and
Y=s2*(B1\hat{ }c)*(B2\hat{ }d),
wherein s1 and s2 are each a sign of value plus or minus one, and wherein a, b, c and d are exponents;
imposing conditions on the exponents as follows:
a, b, c and d are integers, and
a is positive, b is negative, c is negative and d is positive; and
expanding the representation of the sum of X+Y in a log domain as follows:
```
  log (X+Y) = log (s1*(B1\hat{ }a)*(B2\hat{ }b) + s2*(B1\hat{ }c)*(B2\hat{ }d)) =
  log (s1*(B1\hat{ }a*B2\hat{ }d)*(B2\hat{ }(b−d) + (s2/s1)*B1\hat{ }(c−a))), wherein (b−d) is a negative
exponent and (c−a) is a negative exponent.
```

2. The method of claim 1, further comprising:
approximating the value of the sum term B2\hat{ }(b−d)+(s2/s1)*B1\hat{ }(c−a) in the form of a product term as follows:
B2\hat{ }(b−d) + (s2/s1)*B1\hat{ }(c−a) = s3*(B1\hat{ }x)*(B2*y)
within at least 4 bits of precision or within at least 6.4 percent,
wherein s3 is a sign of value plus or minus one; and
wherein x and y are exponents; and
simplifying the representation of the sum of X+Y in the log domain as follows:
```
    log (X+Y) = log (s1*(B1\hat{ }a*B2\hat{ }d)*(B2\hat{ }(b−d) + (s2/s1)*B1\hat{ }(c−a))) =
    log (s1*(B1\hat{ }a*B2\hat{ }d)* s3*(B1\hat{ }x)*(B2*y)) within at least 4 bits of precision or
within at least 6.4 percent =
    log ((s1*s3)*(B1\hat{ }(a+x))*(B2\hat{ }(d+y)));
  wherein X+Y = (s1*s3)*(B1\hat{ }(a+x))*(B2\hat{ }(d+y)) within at least 4 bits of precision or
within at least 6.4 percent.
```

3. The method of claim 2, wherein the exponents a, b, c, d, x and y each have an absolute value of less than or equal to 31.

4. The method of claim 3, wherein X+Y=(s1*s3)*(B1\hat{ }(a+x))*(B2\hat{ }(d+y)) within at least 9 bits of precision or within at least 0.2 percent.

5. The method of claim 3, wherein the value of the sum term B2\hat{ }(b−d)+(s2/s1)*B1\hat{ }(c−a) is within plus or minus two percent of the value of the approximated product term s3*(B1\hat{ }x)*(B2*y).

6. The method of claim 2, wherein:
the value of the product term s3*(B1\hat{ }x)*(B2*y) is derived from a look-up table.

7. The method of claim 1, wherein the base B1 is 2.

8. The method of claim 1, wherein, if initially the sign of the exponent a is negative, rather than positive, and the sign of the exponent b is positive, rather than negative, then the method further comprises:
obtaining an approximate value of 1 represented in the MDLNS as follows:
1~(B1\hat{ }e)*(B2\hat{ }f) within at least 4 bits of precision or within at least 6.4 percent,
wherein e is a positive exponent having an absolute value greater than a, and
wherein f is a negative exponent having an absolute value greater than b;
multiplying and manipulating (B1\hat{ }a)*(B2\hat{ }b) by the approximate value of 1 as follows:
```
    (B1\hat{ }a)*(B2\hat{ }b)*(B1\hat{ }e)*(B2\hat{ }f) = B1\hat{ }(a+e)*B2\hat{ }(b+f)) = (B1\hat{ }a)*(B2\hat{ }b)
within at least 4 bits of precision or within at least 6.4 percent,
    wherein (a+e) is positive and (b+f) is negative; and
  substituting B1\hat{ }(a+e)*B2\hat{ }(b+f)) for (B1\hat{ }a)*(B2\hat{ }b) in the method.
```

9. The method of claim 8, wherein:
the exponents e and f each have an absolute value of less than or equal to 31; and
value of the term (B1\hat{ }e)*(B2\hat{ }f) is within a range of 1 plus or minus 0.02.

10. The method of claim 1, wherein, if initially the sign of the exponent c is positive, rather than negative, and the sign of the exponent d is negative, rather than positive, then the method further comprises:
obtaining an approximate value of 1 represented in the MDLNS as follows:
$$1 = ( B 1 \hat{} e ) * ( B 2 \hat{} f ) ,$$
wherein e is a negative exponent having an absolute value greater than c, and
wherein f is a positive exponent having an absolute value greater than d;
multiplying and manipulating (B1\hat{ }c)*(B2\hat{ }d) by the approximate value of 1 as follows:
```
    (B1\hat{ }c)*(B2\hat{ }d)*(B1\hat{ }e)*(B2\hat{ }f) = B1\hat{ }(c+e)*B2\hat{ }(d+f)) = (B1\hat{ }c)*(B2\hat{ }d)
within at least 4 bits of precision or within at least 6.4 percent,
    wherein (c+e) is negative and (d+f) is positive; and
  substituting B1\hat{ }(c+e)*B2\hat{ }(d+f)) for (B1\hat{ }c)*(B2\hat{ }d) in the method.
```

11. A computer system comprising:
a memory; and
one or more processors in communication with the memory, wherein the computer system is configured to perform a method for performing addition of real numbers represented in a multidimensional logarithmic number system (MDLNS), the method comprising:
representing two real numbers X and Y in an MDLNS, wherein the MDLNS representations of X and Y includes at least two bases B1 and B2, as follows:
$$X = s 1 * ( B 1 \hat{} a ) * ( B 2 \hat{} b ) , and$$
$$Y = s 2 * ( B 1 \hat{} c ) * ( B 2 \hat{} d ) ,$$
wherein s1 and s2 are each a sign of value plus or minus one, and wherein a, b, c and d are exponents,
imposing conditions on the exponents as follows:
a, b, c and d are integers, and
a is positive, b is negative, c is negative and d is positive, and
expanding the representation of the sum of X+Y in the log domain as follows:
```
  log (X+Y) = log (s1*(B1\hat{ }a)*(B2\hat{ }b) + s2*(B1\hat{ }c)*(B2\hat{ }d)) =
  log (s1*(B1\hat{ }a*B2\hat{ }d)*(B2\hat{ }(b−d) + (s2/s1)*B1\hat{ }(c−a))), wherein (b−d) is a
negative exponent and (c−a) is a negative exponent.
```

12. The computer system of claim 11, wherein the method further comprises:
approximating the value of the sum term B2\hat{ }(b−d)+(s2/s1)*B1\hat{ }(c−a) in the form of a product term as follows:
```
    B2\hat{ }(b−d) + (s2/s1)*B1\hat{ }(c−a) = s3*(B1\hat{ }x)*(B2*y) within at least 4 bits of
precision or within at least 6.4 percent,
    wherein s3 is a sign of value plus or minus one; and
    wherein x and y are exponents; and
  simplifying the representation of the sum of X+Y in the log domain as follows:
    log (X+Y) = log (s1*(B1\hat{ }a*B2\hat{ }d)*(B2\hat{ }(b−d) + (s2/s1)*B1\hat{ }(c−a))) =
    log (s1*(B1\hat{ }a*B2\hat{ }d)* s3*(B1\hat{ }x)*(B2*y)) within at least 4 bits of precision or
within at least 6.4 percent =
    log ((s1*s3)*(B1\hat{ }(a+x))*(B2\hat{ }(d+y)));
  wherein X+Y = (s1*s3)*(B1\hat{ }(a+x))*(B2\hat{ }(d+y)) within at least 4 bits of precison.
```

13. The computer system of claim 12, wherein the method further comprises:
the exponents a, b, c, d, x and y each have an absolute value of less than or equal to 31; and
the value of the sum term B2\hat{ }(b−d)+(s2/s1)*B1\hat{ }(c−a) is within plus or minus two percent of the value of the approximated product term s3*(B1\hat{ }x)*(B2*y).

14. The computer system of claim 11, wherein, if initially the sign of the exponent a is negative, rather than positive, and the sign of the exponent b is positive, rather than negative, then the method further comprises:
```
  obtaining an approximate value of 1 represented in the MDLNS as follows:
    1= (B1\hat{ }e)*(B2\hat{ }f) within 4 bits of precision,
    wherein e is a positive exponent having an absolute value greater than a, and
    wherein f is a negative exponent having an absolute value greater than b;
  multiplying and manipulating (B1\hat{ }a)*(B2\hat{ }b) by the approximate value of 1 as follows:
    (B1\hat{ }a)*(B2\hat{ }b)*(B1\hat{ }e)*(B2\hat{ }f) = B1\hat{ }(a+e)*B2\hat{ }(b+f)) = (B1\hat{ }a)*(B2\hat{ }b) within at
least 4 bits of precision or within at least 6.4 percent,
    wherein (a+e) is positive and (b+f) is negative; and
  substituting B1\hat{ }(a+e)*B2\hat{ }(b+f)) for (B1\hat{ }a)*(B2\hat{ }b) in the method.
```

15. The computer system of claim 11, wherein, if initially the sign of the exponent c is positive, rather than negative, and the sign of the exponent d is negative, rather than positive, then the method further comprises:
```
  obtaining an approximate value of 1 represented in the MDLNS as follows:
    1= (B1\hat{ }e)*(B2\hat{ }f) within 4 bits of precision,
    wherein e is a negative exponent having an absolute value greater than c, and
    wherein f is a positive exponent having an absolute value greater than d;
  multiplying and manipulating (B1\hat{ }c)*(B2\hat{ }d) by the approximate value of 1 as follows:
    (B1\hat{ }c)*(B2\hat{ }d)*(B1\hat{ }e)*(B2\hat{ }f) = B1\hat{ }(c+e)*B2\hat{ }(d+f)) = (B1\hat{ }c)*(B2\hat{ }d) within at
least 4 bits of precision or within at least 6.4 percent,
    wherein (c+e) is negative and (d+f) is positive; and
  substituting B1\hat{ }(c+e)*B2\hat{ }(d+f)) for (B1\hat{ }c)*(B2\hat{ }d) in the method.
```

16. A computer program product comprising:
one or more computer readable storage media and program instructions collectively stored on the one or more computer readable storage media readable by at least one processing circuit, wherein the computer program product is configured to perform a method for performing addition of real numbers represented in a multidimensional logarithmic number system (MDLNS), the method comprising:
representing two real numbers X and Y in a multidimensional logarithmic number system (MDLNS), wherein the MDLNS representations of X and Y includes at least two bases B1 and B2, as follows:
$$X = s 1 * ( B 1 \hat{} a ) * ( B 2 \hat{} b ) , and$$
$$Y = s 2 * ( B 1 \hat{} c ) * ( B 2 \hat{} d ) ,$$
wherein s1 and s2 are each a sign of value plus or minus one, and wherein a, b, c and d are exponents;
imposing conditions on the exponents as follows:
a, b, c and d are integers, and
a is positive, b is negative, c is negative and d is positive; and
expanding the representation of the sum of X+Y in the log domain as follows:
```
  log (X+Y) = log (s1*(B1\hat{ }a)*(B2\hat{ }b) + s2*(B1\hat{ }c)*(B2\hat{ }d)) =
  log (s1*(B1\hat{ }a*B2\hat{ }d)*(B2\hat{ }(b−d) + (s2/s1)*B1\hat{ }(c−a))), wherein (b−d) is a negative
exponent and (c−a) is a negative exponent.
```

17. The computer program product of claim 16, wherein the method further comprises:
approximating the value of the sum term B2\hat{ }(b−d)+(s2/s1)*B1\hat{ }(c−a) in the form of a product term as follows:
```
    B2\hat{ }(b−d) + (s2/s1)*B1\hat{ }(c−a) = s3*(B1\hat{ }x)*(B2*y) within at least 4 bits of
precision or within at least 6.4 percent,
    wherein s3 is a sign of value plus or minus one; and
    wherein x and y are exponents; and
  simplifying the representation of the sum of X+Y in the log domain as follows:
    log (X+Y) = log (s1*(B1\hat{ }a*B2\hat{ }d)*(B2\hat{ }(b−d) + (s2/s1)*B1\hat{ }(c−a))) =
    log (s1*(B1\hat{ }a*B2\hat{ }d)* s3*(B1\hat{ }x)*(B2*y)) within at least 4 bits of precision or
within at least 6.4 percent =
    log ((s1*s3)*(B1\hat{ }(a+x))*(B2\hat{ }(d+y)));
  wherein X+Y = (s1*s3)*(B1\hat{ }(a+x))*(B2\hat{ }(d+y)) within at least 4 bits of precision or
within at least 6.4 percent.
```

18. The computer program product of claim 17, wherein the method further comprises:
the exponents a, b, c, d, x and y each have an absolute value of less than or equal to 31; and
the value of the sum term B2\hat{ }(b−d)+(s2/s1)*B1\hat{ }(c−a) is within plus or minus two percent of the value of the approximated product term s3*(B1\hat{ }x)*(B2*y).

19. The computer program product of claim 16, wherein, if initially the sign of the exponent a is negative, rather than positive, and the sign of the exponent b is positive, rather than negative, then the method further comprises:
obtaining an approximate value of 1 represented in the MDLNS as follows:
1=(B1\hat{ }e)*(B2\hat{ }f) within at least 4 bits of precision or within at least 6.4 percent,
wherein e is a positive exponent having an absolute value greater than a, and
wherein f is a negative exponent having an absolute value greater than b;
multiplying and manipulating (B1\hat{ }a)*(B2\hat{ }B) by the approximate value of 1 as follows:
```
    (B1\hat{ }a)*(B2\hat{ }b)*(B1\hat{ }e)*(B2\hat{ }f) = B1\hat{ }(a+e)*B2\hat{ }(b+f)) = (B1\hat{ }a)*(B2\hat{ }b)
within at least 4 bits of precision or within at least 6.4 percent,
    wherein (a+e) is positive and (b+f) is negative; and
  substituting B1\hat{ }(a+e)*B2\hat{ }(b+f)) for (B1\hat{ }a)*(B2\hat{ }b) in the method.
```

20. The computer program product of claim 16, wherein, if initially the sign of the exponent c is positive, rather than negative, and the sign of the exponent d is negative, rather than positive, then the method further comprises:
obtaining an approximate value of 1 represented in the MDLNS as follows:
1=(B1\hat{ }e)*(B2\hat{ }f) within at least 4 bits of precision or within at least 6.4 percent,
wherein e is a negative exponent having an absolute value greater than c, and
wherein f is a positive exponent having an absolute value greater than d;
multiplying and manipulating (B1\hat{ }c)*(B2\hat{ }d) by the approximate value of 1 as follows:
```
    (B1\hat{ }c)*(B2\hat{ }d)*(B1\hat{ }e)*(B2\hat{ }f) = B1\hat{ }(c+e)*B2\hat{ }(d+f)) = (B1\hat{ }c)*(B2\hat{ }d)
within at least 4 bits of precision or within at least 6.4 percent,
    wherein (c+e) is negative and (d+f) is positive; and
  substituting B1\hat{ }(c+e)*B2\hat{ }(d+f)) for (B1\hat{ }c)*(B2\hat{ }d) in the method.
```

21. A computer-implemented method for performing addition of real numbers represented in a multidimensional logarithmic number system (MDLNS), the method comprising:
obtaining, by program code executing on one or more processors, an instruction to sum together a first real number and a second real number;
representing, by the program code, the first and second real numbers an MDLNS, wherein the MDLNS representation of the first and second real numbers includes:
the first real number represented by a first base raised to a first exponent multiplied by a second base raised to a second exponent, and
the second real number represented by the first base raised to a third exponent multiplied by the second base raised to a fourth exponent;
imposing conditions, by the program code, on the exponents, wherein:
the exponents are integers, and
the first exponent is positive, the second exponent is negative, the third exponent is negative and the fourth exponent is positive;
expanding, by the program code, an MDLNS representation of a sum of the first and second real numbers in a log domain;
approximating, by the program code, a value of a portion of the expanded MDLNS representation of the sum in a form of an approximated product term; and
utilizing, by the program code, the approximated product term to simplify the MDLNS representation of the sum of the first and second real numbers, wherein the MDLNS representation of the sum is approximated as the first base raised to a fifth integer exponent multiplied by the second base raised to a sixth integer exponent, and wherein the actual value of the sum and the approximated value of the sum are within at least 4 bits of precision or within at least 6.4 percent.

22. The method of claim 21, wherein the actual value of the sum and the approximated value of the sum are within at least 9 bits of precision or within at least 0.2 percent.
